(19) United States
(12) Patent Application Publication
(10) Pub. No.: US 2015/0068213 A1
(43) Pub. Date: Mar. 12, 2015

(54) METHOD OF COOLING A GAS TURBINE ENGINE

(71) Applicant: General Electric Company, Schenectady, NY (US)

(72) Inventors: Ariel Harter Lomas, Simpsonville, SC (US); Bradley Steven Carey, Greer, SC (US); Kevin Michael Elward, Simpsonville, SC (US); Richard Francis Gutta, Greenville, SC (US); George Jason Kaliope, Greer, SC (US)

(73) Assignee: General Electric Company, Schenectady, NY (US)

(21) Appl. No.: 14/019,891

(22) Filed: Sep. 6, 2013

(51) Int. Cl. F02C 7/12

(52) U.S. Cl. CPC F02C 7/12
USPC 60/772

(57) ABSTRACT

A method of cooling a gas turbine engine is provided. The method includes removing a load from the gas turbine engine. The method also includes operating the gas turbine engine at a rated speed of the gas turbine engine. The method further includes modulating an angle of at least one stage of inlet guide vanes disposed proximate an inlet of a compressor section of the gas turbine engine, wherein modulating the angle modifies a flow rate of an inlet flow for reducing a cooling time of the gas turbine engine.

### BACKGROUND OF THE INVENTION

The subject matter disclosed herein relates to gas turbine engines, and more particularly to a method of cooling a gas turbine engine.

The economy of gas turbine engine operation dictates that gas turbines be available to produce power to the maximum extent possible. However, it is known that planned and unplanned outages for gas turbine maintenance and repair are required over the life of the equipment. It is advantageous to be able to expeditiously shutdown the gas turbine engine, establish the conditions required to perform the maintenance, and then return to operation quickly after the maintenance is complete.

One portion of the process outlined above specifically relates to a cool down procedure for the gas turbine engine, referred to as a cool down cycle. The cool down cycle is associated with operation of the gas turbine engine during a transition from full operation at full speed-full load (FSFL) to complete or temporary shutdown. Users of the gas turbine engine want this process to be performed as quickly as possible to reduce total down time, whether for scheduled maintenance or for unexpected outages. One consideration related to the cool down cycle relates to component life impacts. Specifically, the speed of the cool down process impacts the stresses imposed on various components of the gas turbine engine and such thermal cycling directly impacts component life. Typically, a single time period is provided to the user, based on a conservative determination of acceptable stresses to be imposed on the components.

### BRIEF DESCRIPTION OF THE INVENTION

According to one aspect of the invention, a method of cooling a gas turbine engine is provided. The method includes removing a load from the gas turbine engine. The method also includes operating the gas turbine engine at a rated speed of the gas turbine engine. The method further includes modulating an angle of at least one stage of inlet guide vanes disposed proximate an inlet of a compressor section of the gas turbine engine, wherein modulating the angle modifies a flow rate of an inlet flow for reducing a cooling time of the gas turbine engine.

According to another aspect of the invention, a method of cooling a gas turbine engine is provided. The method includes operating the gas turbine engine at a rated speed of the gas turbine engine. The method also includes decreasing a rotor speed of the gas turbine engine to a first predetermined cool down rotor speed. The method further includes increasing the rotor speed from the first predetermined cool down rotor speed to a second predetermined cool down rotor speed. The method yet further includes modulating an angle of at least one stage of inlet guide vanes to modify a flow rate of an inlet flow. The method also includes injecting water into a region of the gas turbine engine. The method further includes holding the rotor speed at the second predetermined cool down rotor speed for a period of time determined by ambient conditions.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a plot of gas turbine speed as a function of time during a method of cooling a gas turbine engine; and

FIG. 3 is a flow diagram illustrating the method of cooling a gas turbine engine.

The detailed description explains embodiments of the invention, together with advantages and features, by way of example with reference to the drawings.

### DETAILED DESCRIPTION OF THE INVENTION

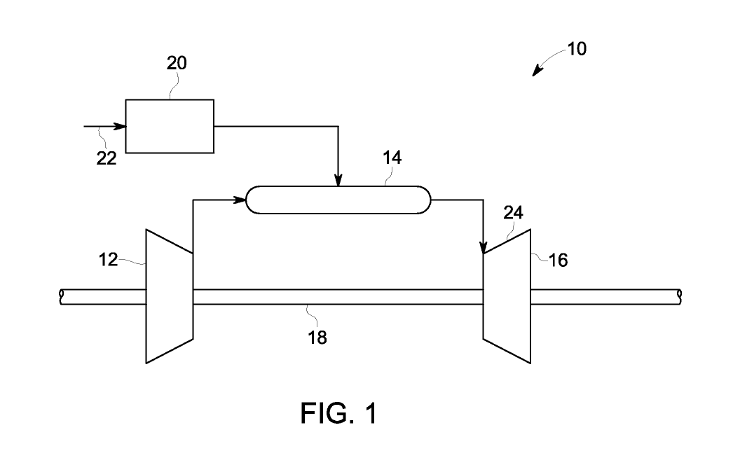

Referring to FIG. 1, a turbine system, such as a gas turbine engine, for example, is schematically illustrated with reference numeral 10. The gas turbine engine 10 includes a compressor section 12, a combustor section 14, a turbine section 16, a rotor 18 and a fuel nozzle 20. It is to be appreciated that one embodiment of the gas turbine engine 10 may include a plurality of compressors 12, combustors 14, turbines 16, rotors 18 and fuel nozzles 20. The compressor section 12 and the turbine section 16 are coupled by the rotor 18. The rotor 18 may be a single shaft or a plurality of shaft segments coupled together to form the rotor 18.

The combustor section 14 uses a combustible liquid and/or gas fuel, such as natural gas or a hydrogen rich synthetic gas, to run the gas turbine engine 10. For example, fuel nozzles 20 are in fluid communication with an air supply and a fuel supply 22. The fuel nozzles 20 create an air-fuel mixture, and discharge the air-fuel mixture into the combustor section 14, thereby causing a combustion that creates a hot pressurized exhaust gas. The combustor section 14 directs the hot pressurized gas through a transition piece into a turbine nozzle (or “stage one nozzle”), and other stages of buckets and nozzles causing rotation of turbine blades within an outer casing 24 of the turbine section 16.

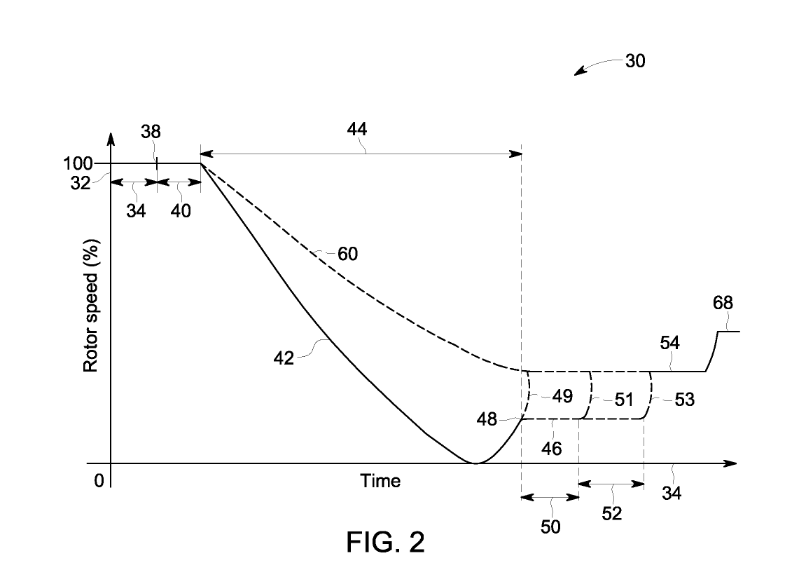

Referring to FIG. 2, a method of cooling 30 the gas turbine engine 10 is illustrated. The method of cooling 30 may be employed in response to a number of scenarios. One example is a planned shutdown of the gas turbine engine 10 due to scheduled maintenance. Another example is an unplanned shutdown due to a variety of factors. Regardless of whether the method of cooling 30 is employed as a result of a planned or unplanned shutdown, the method of cooling 30 advantageously reduces the time required to sufficiently cool components of the gas turbine engine 10. Additionally, the method of cooling 30 provides a user options relating to the cool down time period, as will be described in detail below.

The plot in FIG. 2 illustrates a rotor speed 32 as a function of time during at least a portion of the method of cooling 30 time period. For illustration purposes, the gas turbine engine 10 is shown initially with the rotor speed 32 at 100% and with a load coupled thereto, representing an operating condition of full speed-full load (FSFL) over time period 34. It is to be appreciated that the gas turbine engine 10 often operates at what is referred to as a rated speed that is typically greater than about 90% of the full speed (i.e., 100%) referenced above. As such, the speeds and relative percentages discussed herein may be related to the full speed or the rated speed.

The rotor speed 32 is then decreased 42 over time period 44 to a first predetermined cool down speed 46. The load is removed from the gas turbine engine 10 at time 38 and the gas turbine engine 10 operates briefly at full speed-no load (FSNL), or the rated speed, over time period 40. It is to be appreciated that the load may be removed during time period 44 in some cases. The first predetermined cool down speed 46 will vary depending upon the particular application. In one embodiment, the first predetermined cool down speed 46 comprises what is referred to as a “ratchet speed” or a “turning gear speed.” The terms ratchet speed and turning gear speed each correspond to a relatively slow rotor speed, where the rotor 18 is driven by a mechanical device operatively coupled to the rotor 18. The rotor speed 32 may be defined by an extremely slow constant rotation of the rotor 18 or an intermittent turning. In one embodiment, the first predetermined cool down speed 46 corresponds to about ¼ of a turn of the rotor 18 every 1 to 5 minutes. The precise speed of the first predetermined cool down speed 46 varies depending upon the application. As illustrated, in certain embodiments, the rotor speed 32 may actually decrease to a complete stop, represented by 0% rotor speed, prior to reaching the first predetermined cool down speed 46. In one embodiment, the first predetermined cool down speed 46 corresponds to the turning gear speed and ranges from about 0.1% to about 10% rotor speed.

Upon reaching the first predetermined cool down speed 46, the rotor speed 32 is held at the first predetermined cool down speed 46 for a selectable time period. In particular, a user is provided options between a plurality of time periods in which the rotor speed 32 is held at the first predetermined cool down speed 46. Illustrated are three time periods, referred to as a first time period 48, a second time period 50 and a third time period 52. These time periods represent the holding time at the first predetermined cool down speed 46 prior to increasing the rotor speed 32 to a second predetermined rotor speed 54. In one embodiment, the second predetermined rotor speed 54 may correspond to a “crank speed” of the rotor 18. In such an embodiment, the rotor speed 32 ranges from about 10% to about 40%.

The first time period 48 represents a holding time of about 0 minutes at the first predetermined cool down speed 46. In other words, the rotor speed 32 is increased to the second predetermined cool down speed 54 along line 49 directly past the first predetermined cool down speed 46 or held for a short period of time, such as less than 1 minute. The third time period 52 represents the longest holding time option at the first predetermined cool down speed 46 before increasing the rotor speed 32 to the second predetermined cool down speed 54 along line 53. The second time period 50 represents an intermediate holding time relative to the first time period 48 and the third time period 52. After holding for the second time period 50, the rotor speed 32 is increased along line 51 to the second predetermined cool down speed 46. Although three time durations have been illustrated and described herein, it is to be appreciated that more or less time duration options may be provided to a user. As will be appreciated from the description below, each of the plurality of time periods is associated with a corresponding maintenance factor impact, with the used determining which time period option based on the maintenance factor impact.

Advantageously, the user is able to select from the plurality of time periods based on the specific operation of the gas turbine engine 10. In particular, some users operate the gas turbine engine 10 predominantly at base load (FSFL) and not in a cyclical manner. Such users are not as concerned with rotor cyclic capability, which is influenced by thermal stresses imposed during thermal cycling, as they are with a reduced outage time. These users benefit the most from the option utilizing the first time period 48, with little or no holding time at the first predetermined cool down speed 46. At the opposite end of the spectrum, a user with frequent cycling of the gas turbine engine 10 benefits the most from the third time period 52, which takes longer to bring the gas turbine engine 10 to FSFL, but conservatively accounts for thermal stresses imposed on the rotor 18. The second time period 50 is an intermediate option for users between the above-described extremes. As noted, more or less than the three options described may be employed and the three options are not intended to be limiting.

Regardless of which option the user selects, the rotor speed 32 is increased to the second predetermined cool down speed 54 and held for a time duration that is determined by ambient conditions detected by various devices associated with the gas turbine engine 10. It is contemplated that the ambient conditions may also be employed to determine the plurality of time periods corresponding to the first predetermined cool down speed 46. Such conditions may include temperature, pressure and humidity, for example. The ambient conditions are input automatically or manually into rotor analytical models to determine the time duration for holding at the second predetermined cool down speed 54. At the conclusion of the holding period, the rotor speed 32 may be increased toward full speed or decreased in a full shutdown. Alternatively, the rotor speed 32 may be increased to a third predetermined cool down speed 68 that corresponds to an elevated crank speed.

During operation at the second predetermined cool down speed 54, the method of cooling 30 includes one or more cooling actions employed to facilitate effective and time reducing cooling of the gas turbine engine 10. One cooling action includes modulating an angle of at least one inlet guide vane set. Typically, a plurality of inlet guide vanes (IGVs) are disposed proximate an inlet of the compressor section 12. At least one, but up to all stages of the IGVs may be modulated to alter their respective angles relative to an inlet flow entering the compressor section 12. The angle relative to the inlet flow may be increased or decreased depending on the particular conditions of the gas turbine engine 10. In one embodiment, the IGVs are modulated to a “fully open” position, which fully increases the flow rate of the inlet flow entering the compressor section 12, thereby enhancing the cooling effect on various components of the gas turbine engine 10. The particular angle that the IGVs are modulated to may be fine-tuned to account for distinct operating and/or ambient conditions. Another cooling action that may be employed is an injection of water into at least one region of the gas turbine engine 10 for heat transfer purposes that reduce the cool down time of the gas turbine engine 10. The region(s) into which the water is injected may vary. In one embodiment, the water is injected into the compressor section 12. Such an embodiment cools the air flowing through the compressor section 12, which allows the air to pick up additional heat from the gas turbine engine 10 and further reduce the cool down time duration. In alternative embodiments, it is contemplated that the water is injected into other regions of the gas turbine engine 10, such as the turbine section 16, the combustor section 14, or a combination of the turbine section 16, the combustor section 14 and the compressor section 12.

An alternative embodiment is represented with path 60 that decreases the rotor speed 32 from FSNL, or the rated speed, to the second predetermined rotor speed 54. This embodiment does not require decreasing the rotor speed 32 to a speed corresponding to the first predetermined cool down speed 46 or slower than the first predetermined cool down speed 46. It is to be appreciated that the second predetermined rotor speed 54 in this embodiment may correspond to the crank speed described above, or alternatively may be the elevated crank speed 68, with the elevated crank speed 68 greater than the crank speed being greater than about 40% of full speed, or the rated speed.

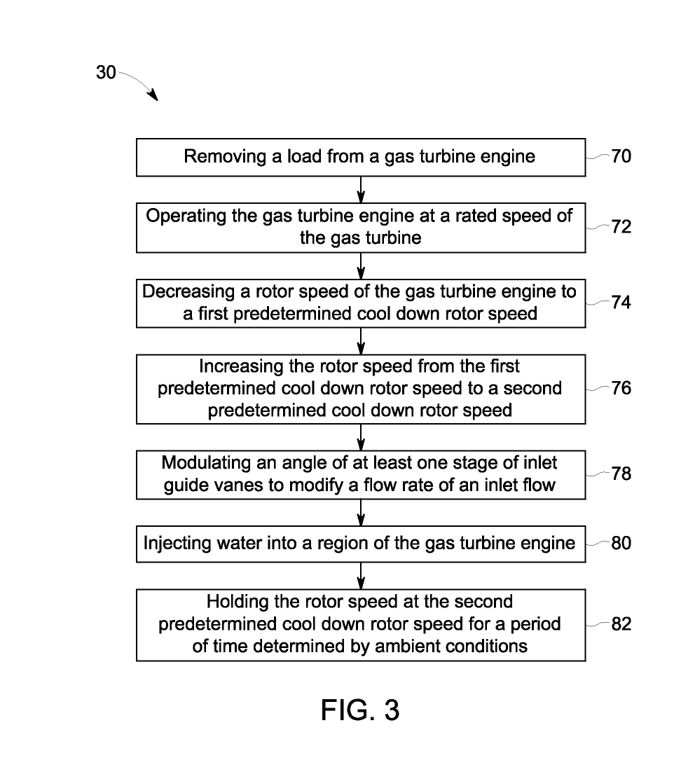

Referring to FIG. 3, a flow diagram further illustrates the method of cooling 30. The method of cooling 30 includes removing a load from the gas turbine engine 70 and operating the gas turbine engine at a rated speed of the gas turbine engine 72. The method also includes decreasing a rotor speed of the gas turbine engine to a first predetermined cool down rotor speed 74. The method further includes increasing the rotor speed from the first predetermined cool down rotor speed to a second predetermined cool down rotor speed 76. The method yet further includes modulating an angle of at least one stage of inlet guide vanes to modify a flow rate of an inlet flow 78. The method also includes injecting water into a region of the gas turbine engine 80. The method further includes holding the rotor speed at the second predetermined cool down rotor speed for a period of time determined by ambient conditions 82. The additional features of the method of cooling 30 are described in detail above with reference to FIG. 2.

Advantageously, the method of cooling 30 provides significant time savings for the cool down process, thereby helping start outage efforts more rapidly. Additionally, a user may select from the plurality of time periods described above to suit the specific operating needs of the gas turbine engine 10, with particular emphasis on the maintenance factor impact associated with each of the time periods.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of cooling a gas turbine engine comprising:
removing a load from the gas turbine engine;
operating the gas turbine engine at a rated speed of the gas turbine engine; and
modulating an angle of at least one stage of inlet guide vanes disposed proximate an inlet of a compressor section of the gas turbine engine, wherein modulating the angle modifies a flow rate of an inlet flow for reducing a cooling time of the gas turbine engine.

2. The method of claim 1, wherein modulating the angle of the at least one stage of inlet guide vanes comprises increasing the flow rate of the inlet flow.

3. The method of claim 1, further comprising injecting water into at least one region of the gas turbine engine.

4. The method of claim 3, wherein the region of the gas turbine engine comprises at least one of a compressor section, a turbine section and a combustion section.

5. The method of claim 1, further comprising decreasing a rotor speed of the gas turbine engine to a first predetermined cool down speed ranging from about 0.1% to about 10% of a full speed of the gas turbine engine.

6. The method of claim 1, further comprising decreasing a rotor speed of the gas turbine engine to a first predetermined cool down speed comprising about ¼ of a turn of the rotor every 1 to 5 minutes.

7. The method of claim 5, further comprising selectively holding the rotor speed at the first predetermined cool down speed for one of a plurality of time periods.

8. The method of claim 7, wherein a user selects from the plurality of time periods based on a maintenance factor impact corresponding to each of the plurality of time periods.

9. The method of claim 8, wherein the plurality of time periods comprises a first time period and a second time period, wherein the second time period is greater than the first time period.

10. The method of claim 7, further comprising:
increasing the rotor speed to a second predetermined cool down speed ranging from about 10% to about 40% of the full speed of the gas turbine engine; and
holding the rotor speed at the second predetermined cool down speed for a second speed time period.

11. The method of claim 10, further comprising:
detecting ambient conditions of an environment of the gas turbine engine; and
determining at least one of the second speed time period and the plurality of time periods based on the ambient conditions.

12. The method of claim 10, wherein the first predetermined cool down speed comprises a ratchet speed and the second predetermined cool down speed comprises a crank speed.

13. The method of claim 1, further comprising:
detecting ambient conditions of an environment of the gas turbine engine;
decreasing a rotor speed of the gas turbine engine to a first rotor speed of the gas turbine engine;
increasing the rotor speed of the gas turbine engine to a second rotor speed corresponding to a crank speed of the gas turbine engine; and
holding the rotor speed at the first rotor speed for a first period of time and at the crank speed for a second period of time, the first period of time and the second period of time determined by the ambient conditions.

14. A method of cooling a gas turbine engine comprising:
operating the gas turbine engine at a rated speed of the gas turbine engine;
decreasing a rotor speed of the gas turbine engine to a first predetermined cool down rotor speed;
increasing the rotor speed from the first predetermined cool down rotor speed to a second predetermined cool down rotor speed;
modulating an angle of at least one stage of inlet guide vanes to modify a flow rate of an inlet flow;
injecting water into a region of the gas turbine engine; and
holding the rotor speed at the second predetermined cool down rotor speed for a period of time determined by ambient conditions.

15. The method of claim 14, wherein modulating the angle of the at least one stage of inlet guide vanes comprises increasing the flow rate of the inlet flow.

16. The method of claim 14, wherein the region of the gas turbine engine comprises a compressor section.

17. The method of claim 14, further comprising selectively holding the rotor speed at the first predetermined cool down rotor speed for one of a plurality of time periods.

18. The method of claim 17, wherein a user selects from the plurality of time periods based on a maintenance factor impact corresponding to each of the plurality of time periods.

19. The method of claim 18, wherein the plurality of time periods comprises a first time period and a second time period, wherein the second time period is greater than the first time period.

20. The method of claim 14, wherein the first predetermined cool down rotor speed comprises about 0.1% to about 10% of a full speed of the gas turbine engine and the second predetermined cool down rotor speed comprises about 10% to about 40% of the full speed.
